(19) United States
(12) Patent Application Publication
(10) Pub. No.: US 2008/0274232 A1
(43) Pub. Date: Nov. 6, 2008

(54) Process for the Manufacture of Cheese

(76) Inventors: Conor Buckley, Cork (IE); Kieran Lonergan, Monaghan (IE)

Correspondence Address: K&L Gates LLP, STATE STREET FINANCIAL CENTER, One Lincoln Street, BOSTON, MA, 02111-2950, US

(21) Appl. No.: 12/158,511

(22) PCT Filed: Dec. 13, 2006
(86) PCT No.: PCT/EP06/69687

§ 371 Date: Jun. 20, 2008

(30) Foreign Application Priority Data
Dec. 22, 2005 (IE) 2005/0864

(51) Int. Cl. A23C 19/064; A23C 19/00; A23L 1/05; A23C 19/02; A23L 1/0532

(52) U.S. Cl. 426/40; 426/573; 426/582

(57) ABSTRACT

The present invention relates to an improved process for the manufacture of cheese, in particular hard and semi-hard cheese types. There is provided a process for the manufacture of a natural cheese comprising the stops of inoculating milk with a bacterial starter culture, adding rennet to form a curd, and subjecting the curd to a salting step by the addition of salt wherein a hydrocolloid or mixture thereof is added to the curd during the salting step and the hydrocolloid or mixture thereof replaces at least part of the salt or is in addition to the salt used during the salting step. There is also provided the use of such a salt and hydrocolloid mixture as a process aid during the salting step of natural cheese production.

### FIELD OF THE INVENTION

This invention relates to an improved process for the manufacture of cheese, in particular hard and semi-hard cheese types,

### BACKGROUND OF THE INVENTION

Cheese making involves a number of steps that are common to most types of cheeses. Generally, the milk is pre-treated, optionally with a bacterial starter culture. It is then mixed with rennet to form a coagulum comprising a mixture of curd and whey. The curd is then cut and the whey is removed. The curd is then processed and placed in cheese moulds to result in a finished cheese. Processing of curd involves several optional steps including cheddaring, milling, salting, hooping and pressing. The different treatments during curd processing determine the characteristics of the cheese. The general processes for manufacturing cheese are well known and The Dairy Processing Handbook published by TetraPak Processing Systems AB provides a general basic outline of the procedures involved.

Salting is an optional step carried out during cheese making after the production of the curd. It is carried out to retard the bacterial starter activity and bacterial processes associated with cheese ripening, as well as assisting with the syneresis of whey and enhancing the flavour and texture of cheese. Salting can be carried out by dry sailing or brine sailing. The salt content of cheese is generally from 0.5 to 2.0% and, for example cheddar cheese generally has a sail content of 1.75 to 1.95% by weight.

The application of salt to curd causes moisture to be expelled, through both an osmotic effect and a salting effect on the proteins. Essentially, during salting, the difference in osmotic pressure causes some moisture together with its dissolved components, including milk proteins milk fat, lactic acid and minerals, to be expelled from the cheese in exchange for sodium chloride. This results in a reduction in the amount of protein and fat in the resultant cheese. Salting may take place by dry salting or brine salting. Dry salting is generally used for medium to hard type cheese, such as cheddar. Brine salting is used for cheese types, such as mozzarella. When preparing a brine solution for brine salting, it is important that consideration is taken of these protein and fat losses during salting. The composition and the temperature of the brine are critical in this regard. The pH at the time of salting has considerable influence on the rate of salt absorption. More salt can be absorbed at a lower pH than at a higher pH. However, high pH and low pH has undesirable effects on the characteristics of the cheese. Temperature also influences the rate of salt absorption of the cheese as the higher the temperature, the higher the rate of salt absorption.

WO 86/00786 is directed to a method for making cheese using carrageenan, preferably, iota carrageenan. This process is concerned with stopping the losses of proteins and other nutrients during curd manufacture which otherwise would be lost as part of the whey. Prior to this, the only method for stopping these losses was to increase the heat treatment of the milk during the basic step of curd formation. However, although increasing the heat treatment reduced the protein losses, it resulted in moisture retention and an undesirable soft texture in the resultant cheese. WO 86/00786 discloses an alternative method for reducing these losses. This method involves adding carrageenan to the milk prior to the addition of acid and/or rennet and hence, prior to curd formation.

U.S. Pat. No. 5,676,984 is directed to a process for preparing a fat-free cream cheese where skim milk is fortified with caseinate and inoculated with a starter bacterial culture, fermented and blended with cheese curd or skim milk curd. The mixture is then heated and various ingredients are added. Stabilising hydrocolloids such as carrageenan and starch are then added and the product is heated and homogenised. The carrageenan and starch in this instance are added to simulate the organoleptic properties of full fat-cream cheese.

WO 91/17663 is directed to the manufacture of a low fat cheese product using milk and a stabilizer such as carrageenan. The carrageenan stabilizer of this patent is added to the starting liquid milk prior to curd formation.

Russian patent number 2200419 and UK patent number 1300711 are directed to processes for preparing processed cheese products, including cream cheese. The steps involved in the preparation of processed cheese differ significantly to the steps involved in the preparation of natural cheese. UK patent number 420,563 relates a process for the manufacture of cheese by adding pectin to cheese curd during production. This document discloses that the pectin can be added at several stages during cheese curd production, however, no salting step is mentioned in this patent.

This loss of proteins and fats in the curd/whey mixture during cheese making reduces the overall cheese yield and is of significant commercial importance. The present invention is directed to an improved process for reducing these protein and fat losses that occur during the salting process.

### STATEMENT OF THE INVENTION

The present invention provides an improved process for the manufacture of natural rennet coagulated cheese, in particular hard and semi-hard cheese types.

Natural cheese according to the present invention will be understood to be natural cheese according to the Codex Ailimentarius definition. Typically, such natural cheese is the ripened or unripened soft, semi-hard, hard, or extra-hard product, which may be coated, and in which the whey protein/casein ratio does not exceed that of milk, obtained by (a) coagulating wholly or partly the protein of milk, skimmed milk, partly skimmed milk, cream, whey cream or buttermilk, or any combinations of these materials, through the action of rennet or other suitable coagulating agents, and by partially draining the whey resulting from the coagulation, while respecting that cheese making results in a concentration of milk protein (in particular, the casein portion), and that consequently, the protein content of the cheese will be distinctly higher than the protein level of the blend of tile above milk materials from which the cheese was made; and/or (b) processing techniques involving the coagulation of the protein of milk and/or products obtained from milk which give an end-product with similar physical, chemical and organoleptic characteristics as defined under (a).

More specifically, the present invention relates to natural cheeses that are made by processes which consist of four basic steps including inoculating, coagulating, draining and dry salting. Processed cheese manufacture on the other hand incorporates extra steps, including blending, and melting and generally does not include coagulating and draining. Thus, it will be understood that natural cheese according to the invention does not include processed cheese, such as cheese spreads, made by blending different types of cheese or the same type of cheese at different stages of ripening. Generally processed cheese includes cheese and other permitted ingredients such as cream and skimmed milk powder.

According to one aspect, the present invention provides a process for the manufacture of natural cheese comprising the steps of:

a. inoculating milk with a bacterial starter culture;

b. adding rennet to form a curd;

c. optionally draining whey produced during step (b); and

d. subjecting the curd to a salting step by the addition of salt;

characterised in that a hydrocolloid or mixture thereof is added to the curd during the salting step and the hydrocolloid or mixture thereof replaces at least part of the salt or is in addition to the salt used during the salting step.

According to a second aspect, the present invention provides the use of a salt and a hydrocolloid mixture during the salting step of natural cheese production wherein the hydrocolloid or mixture thereof is added to curd during the sailing step and the hydrocolloid or mixture thereof replaces at least part of the salt or is in addition to the salt used during the salting step.

### DETAILED DESCRIPTION OF THE INVENTION

During the salting step of cheese manufacture fats and proteins are lost. The present invention is directed to an improved process which reduces these losses and hence improves cheese yield. Any improvement in cheese yield however slight, is likely to be very important commercially. For example, an increase in cheese yield from 10.6 to 10.8 kgs of cheese per 100 kgs of milk in a cheese plant which processes 1 billion litres of milk per year translates to an extra 2000 metric tonnes of cheese per year. This is of significant commercial importance.

During natural cheese manufacture, the curd may be subjected to a salting step wherein salt is added to the curd. This can assist in enhancing the flavour and texture of the resultant cheese.

According to one general embodiment of the invention, there is provided a hydrocolloid or mixture thereof which is added to curd during the salting step of cheese manufacture wherein the hydrocolloid or mixture thereof replaces at least part of the salt or is in addition to the salt used during the salting step.

It will be understood that the hydrocolloid acts as a process aid to improve the efficiency of the salting process during the production of cheese. The hydrocolloid does not have an effect on the characteristics of the resultant cheese that is manufactured but provides for a greater resultant cheese yield.

According to an alternative embodiment of the invention, the hydrocolloid or mixture thereof may be pre-mixed with salt and the resultant salt and hydrocolloid mixture may then replace all of the salt used in the salting step or at least a part thereof. Preferably, the salt and hydrocolloid mixture replaces all of the salt normally used during the salting step.

Ideally, salting occurs by dry salting. Preferably, sodium chloride is used.

According to a more detailed embodiment of the invention, there is provided a process for the manufacture of cheese comprising the steps of inoculating milk with a bacterial starter culture, adding rennet to form a curd and subjecting the curd to a salting step wherein a hydrocolloid or mixture thereof is added to the curd during the salting step and the hydrocolloid mixture replaces at least pan or the salt or is in addition to the salt used during the salting step.

Ideally, the hydrocolloid or mixture thereof is pre-mixed with salt and the resultant salt and hydrocolloid mixture replaces all of the salt used in the salting step or at least a part thereof. Most preferably, the salt and hydrocolloid mixture replaces all of the salt normally used during the salting step.

Preferably, the hydrocolloid or mixture thereof, or the salt and hydrocolloid mixture used in the salting step is added at a level of from approximately 1% to approximately 5% based on the weight of the curd, more preferably from approximately 1% to approximately 3% based on the weight of the curd, even more preferably at approximately 2.5% based on the weight of the curd.

This hydrocolloid mixture of the invention when used during the salting step ensures improved fat and protein recovery in the resultant cheese, higher moisture absorption, reduced salt whey generation and improved salt retention.

Furthermore, this method provides the additional advantage of increased cheese yield with associated significant economic benefits.

The hydrocolloids used in the invention may be selected from one of the following guar gum, pectin, konjac, locust bean gum, xanthan gum and mixtures of such gums. Other such hydrocolloids include gelatine, food starches and plant-derived hydrocolloids, such as agar, alginate, carrageenan (kappa, iota and lambda) and mixtures thereof.

Preferably, the hydrocolloid mixture comprises one or more of the following hydrocolloids xanthan, carrageenan and/or food starch or a mixture thereof.

Preferably, the primary hydrocolloid is a carrageenan. Carrageenan is a group of galactan polysaccharides extracted from red algae and has an ester content of 20% or more. Carrageenan is generally a mixture of several polysaccharides, but primarily consists of three components, kappa, lambda and iota. Semi-refined or refined carrageenans may be used.

More preferably the hydrocolloid is a kappa-carragennan. It is thought that kappa-carragennan interacts with the casein in the curd to form a network that will reduce the loss of fat and protein.

Alternatively, the carrageenan may be a mixture of kappa- and lambda-carrageenan. The carrageenan may be obtained from the species Gigartina or Eucheuma cottonii (dried seaweed) or other species.

The cartageenan may be processed by alcohol processing, including treatment in solution followed by precipitation with alcohol, or may be processed by gel pressing, including alkali treatment followed by the formation of a gel which is then pressed to remove water.

Xanthan gum is a microbial desiccation-resistant polymer prepared commercially by aerobic submerged fermentation from Xanthomonoas campestris. Xanthan gum is a long-chain polysaccharide composed of the sugars glucose, mannose and glucuronic acid.

Starch is one of the most widely used hydrocolloids used in food systems. Food starches include any starch, whether native or modified, permitted for use in food applications. Such starches include corn starch, potato starch, rice starch and modified food starches. Preferably, modified food starch is used, including Gel-N-Mell® from National Starch.

Sodium chloride is the salt generally used in the salting step of natural cheese. Other salts, such as emulsifying salts are not permitted by various regulations for use during the manufacture of natural cheese.

Advantageously, the hydrocolloid mixture of the invention comprises carrageenan, food starch and xanthan gum and salt in the form of sodium chloride.

Alternatively, the hydrocolloid mixture comprises salt, in the form of sodium chloride, carragennan and food starch.

Alternatively, the hydrocolloid mixture comprises salt, in the form of sodium chloride, carragennan and xanthan.

The salt and hydrocolloid mixture may comprise from approximately 70 to 99% by weight of salt and from approximately 1 to 30% by weight of a hydrocolloid or mixture thereof. Preferably, the salt and hydrocolloid mixture comprises from approximately 80 to 98% by weight of salt and from approximately 2 to 20% by weight of a hydrocolloid or mixture thereof. More preferably, the salt and hydrocolloid mixture comprises from approximately 90 to 97% by weight of salt and from approximately 3 to 10% by weight of a hydrocolloid or mixture thereof.

According to a further embodiment, the salting step takes place at a pH of from approximately 5.0 to approximately 6.0, preferably from approximately 5.3 to approximately 5.6, most preferably at approximately 5.6.

According to a still further embodiment, salting takes place at a temperature of from 20 to 35° C., preferably from 24 to 28° C., most preferably at approximately 28° C.

According to yet another embodiment, the hydrocolloid mixture may comprise xanthan and carrageenan at a ratio from 1:4 to 1:8.

The hydrocolloid may also comprise carragennan and food starch at a ratio of from 1:1 to 3:1.

Preferably, xanthan is used at levels of from 0% to 3% by weight of the salt/hydrocolloid mixture, carrageenan at levels of from 3% to 5% by weight of the s salt/hydrocolloid mixture and/or food starch is used at levels of from 2% to 4% by weight of the salt/hydrocolloid mixture.

Optionally, calcium chloride may be added to the milk inoculated with bacterial starter culture.

Optionally, the process may further comprise the step of draining the whey produced du ring the formation of the curd.

Optionally, cheddaring and milling takes place prior to salting.

According to a further embodiment of the invention, there is provided a cheese made in accordance with the process of the invention.

According to yet another embodiment of the invention, there is provided the use of a salt and a hydrocolloid mixture during the salting step of natural cheese production wherein the hydrocolloid or mixture thereof is added to curd during the salting step and the hydrocolloid or mixture thereof replaces at least part of the salt or is in addition to the salt used during the salting step. The hydrocolloid acts as a process aid to improve the efficiency of the salting process during the production of cheese

Preferably, the salt and hydrocolloid mixture comprises from approximately 70 to 99% by weight of salt and from approximately 1 to 30% by weight of a hydrocolloid and the salt and hydrocolloid mixture replaces at least part of the salt or is in addition to the salt used during the salting step.

Ideally, tie hydrocolloid comprises either

a. carrageenan and food starch at a ratio from 1:1 to 3:1; or

b. xanthan and carrageenan at a ratio from 1:4 to 1:8.

As with the previous embodiments, ideally, the salt and hydrocolloid mixture replaces all of the salt used during the salting step. Preferably, salt and hydrocolloid mixture is added to the curd during the salting step at a level of from approximately 1% to approximately 5%, preferably from approximately 1% to 3%, more preferably at approximately 2.5% based on the %weight of the curd. Furthermore, preferably the salt is sodium chloride.

It will be understood that cheese manufactured according to the invention includes natural cheeses such as hard and semi-hard cheese, such as medium-moisture cheese including cheddar. American and provolone; and low moisture cheese such as romano and parmesan.

Rennet is used during cheese manufacture according to the invention.

According to a further embodiment of the invention, the cheese may further comprise further conventional ingredients for cheese manufacture such as colourants, such as annatto.

### DESCRIPTION OF THE FIGURES

FIG. 1 shows the results in terms of cheese yield increase obtained in Example 1.

FIG. 2 shows the results in terms of salt whey reduction obtained in Example 1.

The invention will be illustrated by the following non-limiting examples.

### EXAMPLES

### Example 1

### Preparation of Cheddar Cheese:

The following process was used in the manufacture of the cheddar cheese according to the invention.

Pasteurised and standardised milk vas heated to a temperature of approximately 31° C. The mixture was inoculated with a mesophilic lactic culture of 1-2% depending on activity of the starter. After 30 minutes 0.02% CaCl₂ was added, followed by 0.1% of double strength rennet. The curd was cut 30 minutes after rennet addition. The curd was then stirred gently and heated to 38° C. in 30 minutes. The curd was stirred at 38° C. until the pH reached 6.2. At pH 6.2 the whey was drained. Cheddaring then took place at 36° C. for approximately 2 hours. The curd was then milled at pH 5.4. The curd was then subjected to a salting step. The amount of salt added was approximately 2.5% based on the weight of curd. The salt and hydrocolloid mixtures listed in Table 1a replaced the normal salt used in this procedure. Controls were carried out using regular salt. After salting the usual hooping, pressing overnights vacuum packing and ripening at 9° C. took place.

The following hydrocolloid formulations were used in the Examples. Two sets of trials were carried out.

Each of the components of Trial 1 are listed as follows: S-1 comprised Xanthan 0.6%, Carragennan A 3% and 96.4% Salt (NaCl). S-2 comprised 93.9% Salt (NaCl), 2.2% Carragennan B and 3.9% Modified Food Starch. S-3 comprised 92.9% Salt (NaCl), 3.2% Carragennan B and 3.9% Modified Food Starch. S-4 comprised 92.9% Salt (NaCl) and 3.2% Carragennan A and Xanthan 3.9%. The Control S-C contained 100% Salt (NaCl).

Each of the components of Trial 2 are listed as follows: A-1 comprised Xanthan 1%, Carragennan A 4% and 95% Salt (NaCl). A-2 comprised 94% Salt (NaCl), 6%

Carragennan A. A-3 comprised 93% Salt (NaCl), 5% Carragennan A and 2% Xanthan. A-4 comprised 91% Salt (NaCl) and 3% Carragennan A and Xanthan 3% and 2% modified starch. The Control S-C contained 100% Salt (NaCl). A-5 comprised Carragennan A 6%, Modified Food Starch 2% and Salt (NaCl) 92%. A-6 comprised Xanthan 1%, Carragennan A 3%, Modified Food Starch 2% and Salt (NaCl) 94%.

Carragennan A is a carrageenan obtained from Gigertina containing a mixture of kappa and lambda carrageenan which is processed by alcohol processing. The carrageenan is treated in solution followed by precipitation with alcohol. Carragennan B is a carrageenan obtained front Eucheuma cotonii produced by gel pressing which involves alkali treatment followed by the formation of a gel which is then pressed to remove water. The food starch used was Get-N-Melt® from National Starch.

TABLE 1B
TRIAL 1

| | S-1 | S-2 | S-3 | S-4 | Control S-C |
|---|---|---|---|---|---|
| % Weight of | 6.8 | 6.8 | 6.8 | 6.8 | 6.8 |
| Curd (Kgs) | | | | | |
| Salt/hydrocolloid | 0.18 | 0.18 | 0.18 | 0.18 | 0.18 |
| added (kgs) | | | | | |
| Colloid Added (kgs) | 0.0064 | 0.011 | 0.013 | 0.013 | 0.000 |

TRIAL 2

| | | | | | | | Control |
|---|---|---|---|---|---|---|---|
| | A-1 | A-2 | A-3 | A-4 | A-5 | A-6 | A-C |
| % Weight of | 6.8 | 6.8 | 6.8 | 6.8 | 6.8 | 6.8 | 6.8 |
| Cheese (Kgs) | | | | | | | |
| Salt/hydrocolloid | 0.18 | 0.18 | 0.18 | 0.18 | 0.18 | 0.18 | 0.18 |
| added (kgs) | | | | | | | |
| Colloid added | 0.009 | 0.011 | 0.013 | 0.016 | 0.015 | 0.011 | 0.000 |
| (kgs) | | | | | | | |

### Results:

In both trials the salt whey was collected and weighed to enable the salt/they loss to be measured. The results are shown in Table 2.

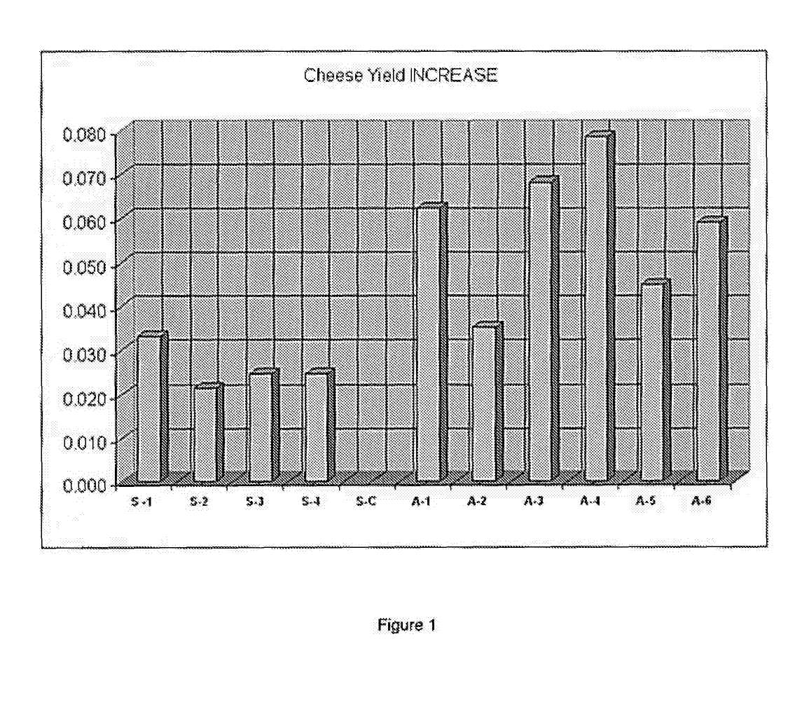

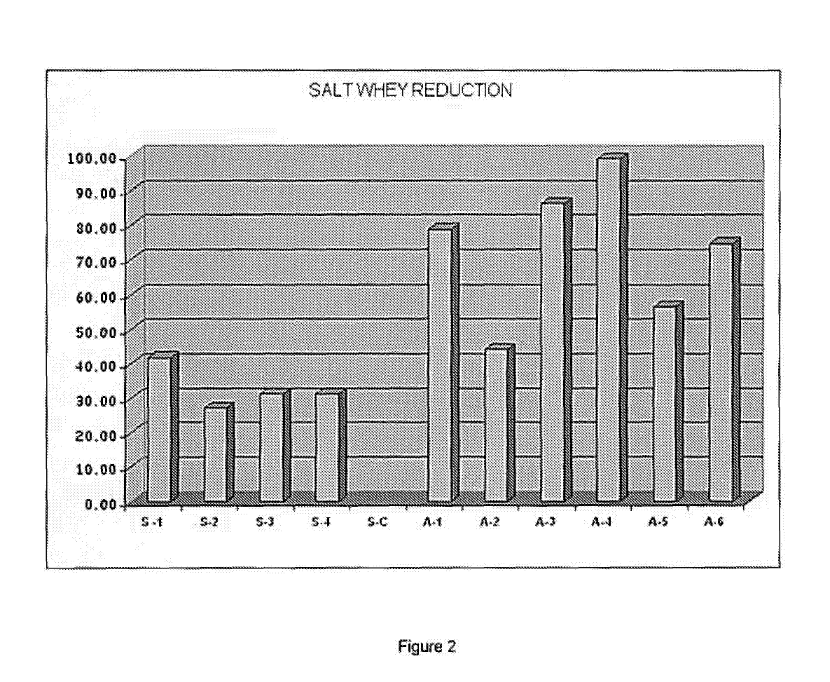

As can be seen from FIGS. 1 and 2, the use of a hydrocolloid mixture during the saltine step results in an increase of the yield of cheese compared to the controls (S-C and A-C). Trial Nos. A-1, A-3 and A-4 gave the best results. A-1, A-3 and A-4 used xanthan at levels of from 1% to 3% by weight of the salt/hydrocolloid mixture and carrageenan at levels of from 3% to 5% by weight of the salt/hydrocolloid mixture. These results are shown in Table 2 below.

TABLE 2
TRIAL 1 RESULTS

| | S-1 | S-2 | S-3 | S-4 | Control S-C |
|---|---|---|---|---|---|
| Total Salted Curd (kgs) | 7 | 7 | 7 | 7 | 7 |
| Salt Whey Loss (kgs) | 0.32 | 0.40 | 0.38 | 0.38 | 0.55 |
| Salt Whey Reduction (%) | 41.80 | 27.05 | 31.15 | 31.15 | — |
| % Final Cheese (kgs) | 6.66 | 6.58 | 6.60 | 6.60 | 6.43 |
| % Increase Vs Control | 3.3 | 2.1 | 2.5 | 2.5 | — |

TRIAL 2 RESULTS

| | | | | | | | Control |
|---|---|---|---|---|---|---|---|
| | A-1 | A-2 | A-3 | A-4 | A-5 | A-6 | A-C |
| Total Salted Curd | 7 | 7 | 7 | 7 | 7 | 7 | 7 |
| (kgs) | | | | | | | |
| Salt Whey Loss | 0.12 | 0.31 | 0.08 | 0.00 | 0.24 | 0.14 | 0.55 |
| (kgs) | | | | | | | |
| Salt Whey | 78.69 | 44.26 | 86.07 | 99.18 | 56.56 | 74.59 | — |
| Reduction (%) | | | | | | | |
| % Final Cheese | 6.86 | 6.67 | 6.78 | 6.98 | 6.74 | 6.84 | 6.43 |
| (kgs) | | | | | | | |
| % Increase Vs | 6.2 | 3.5 | 6.8 | 7.9 | 4.5 | 5.9 | — |
| Control | | | | | | | |

### Example 2

### Further Preparation of Cheddar Cheese

The process outlined in Example 1 was followed. As with Example 1, the salt and hydrocolloid mixtures listed in the following Ingredients Table replaced the normal salt used in this procedure.

These trials were carried out it triplicate. Controls were carried out using regular salt. Control 1, 2 and 3 comprised 100% Salt (NaCl). M-1, m-2 and m-3 comprised 95% Salt (NaCl), Carragennan 3.5%, Food Starch 1.0% and Xanthan 0.5%.

The following results were obtained. These results are the average of three separate sets of trials carried out in accordance with the process of Example 1.

| | | | | | | | Moisture (%) | |
|---|---|---|---|---|---|---|---|---|
| | Weight (Kgs) | | Protein (%) | | Fat (%) | | Con- | |
| | Control | Ex. 2 | Control | Ex. 2 | Control | Ex. 2 | trol | Ex. 2 |
| Milk | 50 | 50 | 3.18 | 3.18 | 3.48 | 3.48 | 87.91 | 87.91 |
| Whey | 43.83 | 43.75 | 0.92 | 0.92 | 0.49 | 0.50 | 93.23 | 93.35 |
| Salt | 0.63 | 0.49 | 1.20 | 1.13 | 0.56 | 0.50 | 84.83 | 84.26 |
| Whey | | | | | | | | |
| Cheese | 4.81 | 4.98 | 23.15 | 23.15 | 30.89 | 29.64 | 40.84 | 41.24 |

| | | |
|---|---|---|
| MACY | Control | 9.18 |
| (Moisture | Example 2 | 9.41 |
| adjusted | | |
| cheese yield) | | |
| Cheese Salt | Control | 1.24% |
| (%) | Example 2 | 1.28% |

For comparison with the results of example 1, the results are presented below in a similar manner.

| Kgs | Control 1 | M1 | Control 2 | M2 | Control 3 | M3 |
|---|---|---|---|---|---|---|
| Curd | 6 | 6.25 | 6.3 | 6.25 | 6.45 | 6.5 |
| Salt whey | 0.58 | 0.50 | 0.55 | 0.43 | 0.75 | 0.55 |
| Cheese | 4.6 | 4.73 | 4.84 | 5.04 | 4.98 | 5.17 |
| Cheese yield increase % | | 2.83% | | 4.13% | | 3.82% |
| Average cheese yield | 3.59% | | | | | |
| increase % | | | | | | |
| Average MACY | 2.50% | | | | | |
| increase % | | | | | | |

As can be seen the Moisture Adjusted Cheese Yield (MACY) value of the Control is 9.18 kgs of cheese per 100 kgs of milk whereas the MACY value of the cheese prepared according to the invention is 9.41 kgs of cheese yield per 100 kgs of milk. This increase in MACY value is the equivalent to a 25% increase in cheese yield.

This difference is significant, in particular provides great advantages when making cheese on a commercial scale.

1. An improved salting process for the manufacture of hard or semi-hard cheese comprising:
a. inoculating milk with a bacterial starter culture;
b. adding rennet to form a curd; and
c. subjecting the curd to a salting step by the addition of salt;
wherein a hydrocolloid or mixture thereof is added to the curd during the salting step and the hydrocolloid or mixture thereof replaces part of the salt or is in addition to the salt used during the salting step.

2. The process according to claim 1 wherein the hydrocolloid or mixture thereof is pre-mixed with part of the salt and the resultant salt and hydrocolloid mixture replaces part of the salt used during the salting step.

3. The process according to claim 1 wherein the hydrocolloid or mixture thereof is pre-mixed with part of the salt and the resultant salt and hydrocolloid mixture replaces all of the salt used during the salting step.

4. The process according to any of claim 1 wherein the hydrocolloid is selected from one or more of the following xanthan gum, guar gum, pectin, konjac gum, locust bean gum, gelatine, food starch and/or plant-derived hydrocolloids, such as agar, alginate, carrageenan or a mixture thereof.

5. The process according to any of claim 1 wherein the hydrocolloid comprises one or more of the following xanthan, carrageenan and/or food starch or a mixture thereof.

6. The process according to claim 1 wherein the hydrocolloid mixture comprises xanthan and carrageenan

7. The process according to claim 1 wherein the hydrocolloid mixture comprises xanthan and carageennan at a ratio from 1:4 to 1:8.

8. The process according to claim 1 wherein the hydrocolloid mixture comprises carageenan and food starch.

9. The process according to claim 1 wherein the hydrocolloid mixture comprises carrageenan and food starch at a ratio from 1:1 to 3:1.

10. The process according to claim 1 wherein the salt is sodium chloride.

11. The process according to claim 1 wherein the salt and hydrocolloid mixture is added to the curd at a level of from approximately 1% to approximately 5%, preferably from approximately 1% to 3%, more preferably at approximately 2.5% based on the weight of the curd.

12. The process according to claim 1 wherein the total amount of salt and hydrocolloid added during the salting step is approximately 70 to 99% by weight of salt and from approximately 1 to 30% by weight of a hydrocolloid or mixture thereof.

13. The process according to claim 1 wherein calcium chloride is added to the milk inoculated with bacterial starter culture.

14. The process according to claim 1 wherein cheddaring and milling takes place prior to salting.

15. The process according to claim 1 wherein the hard or semi-hard cheese is a cheddar cheese.

16. The process according to claim 1 wherein the salting step takes place at a pH of from approximately 5.0 to approximately 6.0, preferably from approximately 5.3 to approximately 5.6, most preferably at approximately 5.6.

17. The process according to claim 1 wherein salting step takes place at a temperature of from 20 to 35° C., preferably from 24 to 28° C., most preferably at approximately 28° C.

18. The process according to claim 1 further comprising the step of draining the whey produced after step (b).

19. The process according to claim 1 wherein the salting method used is dry-salting.

20. A cheese made in accordance with the process of claim 1.

21. Use of a salt and a hydrocolloid mixture as a process aid during the salting step of hard and semi-hard cheese production wherein the hydrocolloid or mixture thereof is added to curd during the salting step and the hydrocolloid or mixture thereof replaces part of the salt or is in addition to the salt used during the salting step.

22. Use according to claim 21 wherein the hydrocolloid or mixture thereof is pre-mixed with part of the salt used during the salting step and the resultant salt and hydrocolloid mixture replaces part of the salt used during the salting step.

23. Use according to claim 21 wherein the hydrocolloid or mixture thereof is pre-mixed with part of the salt and the resultant salt and hydrocolloid mixture replaces all of the salt used during the salting step.

24. Use according to claim 21 wherein the hydrocolloid is selected from one or more of the following xanthan gum, guar gum, pectin, konjac gum, locust bean gum, gelatine, food starch and/or plant-derived hydrocolloids, such as agar, alginate, carrageenan or a mixture thereof.

25. Use according to claim 21 wherein the hydrocolloid comprises one or more of the following xanthan, carrageenan and/or food starch or a mixture thereof.

26. Use according to claim 21 wherein the hydrocolloid comprises
a. carrageenan and food starch, preferably at a ratio from 1:1 to 3:1; or
b. xanthan and carrageenan, preferably at a ratio from 1:4 to 1:8.

27. Use according to claim 21 wherein the total amount of salt and hydrocolloid added during the salting step comprises from approximately 70 to 99% by weight of salt and from approximately 1 to 30% by weight of a hydrocolloid.

28. Use according to claims 21 wherein the salt and hydrocolloid mixture is added to the curd during the salting step at a level of from approximately 1% to approximately 5%, preferably from approximately 1% to 3%, more preferably at approximately 2.5% based on the weight of the curd.

29. Use according to claim 21 wherein the salt is sodium chloride.
